(19) United States
(12) Patent Application Publication
(10) Pub. No.: US 2006/0146527 A1
(43) Pub. Date: Jul. 6, 2006

(54) Lighting device

(76) Inventor: Carl R. VanderSchuit, San Diego, CA (US)

Correspondence Address: HARNESS, DICKEY, & PIERCE, P.L.C, 7700 BONHOMME, STE 400, ST. LOUIS, MO, 63105, US

(21) Appl. No.: 10/541,097

(22) PCT Filed: Jun. 10, 2004
(86) PCT No.: PCT/US04/18799

§ 371 Date: Jan. 10, 2006

(30) Foreign Application Priority Data
Jun. 25, 2003 (US) 10/606324

(51) Int. Cl. F21S 19/00

(52) U.S. Cl. 362/228; 362/229; 362/650

(57) ABSTRACT

Lighting devices and methods include a base portion for engaging a light socket, and a socket for receiving a light bulb. At least one light source is coupled to the base portion. The base portion is electrically connected to the device's socket to apply electrical power from the light socket to the light bulb. The base portion can also be electrically connected to the light source to apply electrically power form the light socket to the light source.

### BACKGROUND OF THE INVENTION

Lighting devices are available in a wide variety of designs, colors, sizes, and shapes. Despite the wide variety of existing lighting devices, the inventor has recognized a need for, among other things, lighting devices compatible with existing light sockets, wall outlets, and light bulbs and lighting devices operable in various modes to produce different modes, types and/or levels of illumination in accordance with user input.

### SUMMARY OF THE INVENTION

In order to solve these and other needs in the art, the inventor hereof has succeeded at designing lighting devices and methods. In one exemplary embodiment, the lighting device includes a base portion for engaging a light socket. The device further includes a socket for receiving a light bulb. At least one light source is coupled to the base portion. The base portion is electrically connected to the device's socket to apply electrical power from the light socket to the light bulb. The base portion can also be electrically connected to the light source to apply electrical power from the light socket to the light source.

Further areas of applicability of the present invention will become apparent from the detailed description provided hereinafter. It should be understood that the detailed description and specific examples below, while indicating exemplary embodiments of the invention, are intended for purposes of illustration only and are not intended to limit the scope of the invention.

### BRIEF DESCRIPTION OF THE DRAWINGS

The present invention will be more fully understood from the detailed description and the accompanying drawings, wherein:

FIG. 1 is a perspective view of a lighting device according to one exemplary embodiment of the present invention;

FIG. 2 is a perspective view of the lighting device of FIG. 1 installed in a light socket;

FIG. 3 is a perspective view of a lighting device according to another exemplary embodiment of the present invention;

FIG. 4 is a schematic block diagram of a light source, a power source and a control circuit of the lighting device shown in FIG. 1 according to one exemplary embodiment of the present invention;

FIG. 5 is a perspective view of a lighting device according to another exemplary embodiment of the present invention;

FIG. 6 is a perspective view of a lighting device according to another exemplary embodiment of the present invention;

FIG. 7 is a perspective view of a lighting device according to another exemplary embodiment of the present invention;

FIG. 8 is a perspective view of a lighting device according to another exemplary embodiment of the present invention; and

FIG. 9 is a perspective view of a lighting device according to one exemplary embodiment of the present invention.

### DETAILED DESCRIPTION OF EXEMPLARY EMBODIMENTS

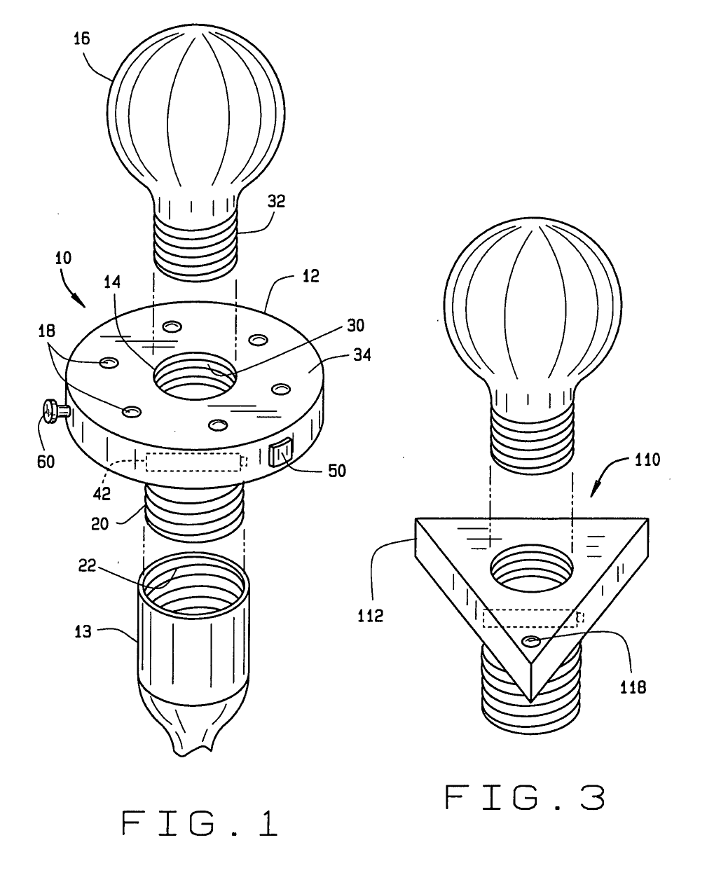

A lighting device according to one embodiment of the invention is indicated generally in FIG. 1 by reference number 10. As shown, the lighting device 10 includes a base portion 12 for engaging a light socket 13. The device 10 further includes a socket 14 for receiving a light bulb 16, such as an incandescent, halogen or black light bulb. The device 10 is also provided with one or more light sources 18 coupled to the base portion 12. The base portion 12 is electrically connected to the device's socket 14 to apply electrical power from the light socket 13 to the light bulb 16 received within the device's socket 14. The base portion 12 can also be electrically connected to the light sources 18 to apply electrical power from the light socket 13 to the light sources 18. Alternatively, or additionally, the base portion 12 can be adapted to receive therein a power source 42 (shown in phantom) for applying electrical power to the light sources 18;

As shown in FIG. 1, the base portion 12 includes a threaded extension 20 adapted to threadedly engage the threaded portion 22 of the light socket 13. The device's socket 14 includes a threaded portion 30 adapted to threadedly engage the threaded stem 32 of the light bulb 16. Alteratively, other suitable methods for engaging the device's socket 14 with the light bulb 16 are possible, including the use of bayonets or lugs which are commonly employed with direct current (DC) environments.

In at least some embodiments, the base portion 12 is removably engaged with the socket extension 20 with an suitable locking mechanism such as locking pins and detents, bayonets, etc. The locking mechanism selected to releasably secure the base portion 12 to the socket extension 20 is preferably readily accessible to the user and allows the base portion 12 to be readily engaged with and disengaged from the socket extension 20.

In at least one embodiment, the light socket 13 and the device's socket 14 are both medium base sockets, and the threaded extension 20 of the base portion 12 is sized to be received with a medium base socket. Medium base sockets are widely used today. Accordingly, the device 10 can thus be used in conjunction with many currently available lamps, ceiling-supported light sockets, ceiling fans, among other lighting fixtures having medium base sockets. The device 10 is also compatible with a wide range of existing and currently available light bulbs, including incandescent, halogen, and black light bulbs of various sizes, shapes (e.g., a-shape, tubular, globe, chandelier, etc.), intensities, brightness, colors, bulb wattages, life expectancy, etc. As should be apparent, however, other sizes may be employed for the device's socket 14 and the threaded extension 20 of the base portion 12.

In FIG. 1, the device socket 14 is positioned at about a center of a surface 34 of the base portion 12. Alternatively, the device socket 14 can be positioned elsewhere on the device 10.

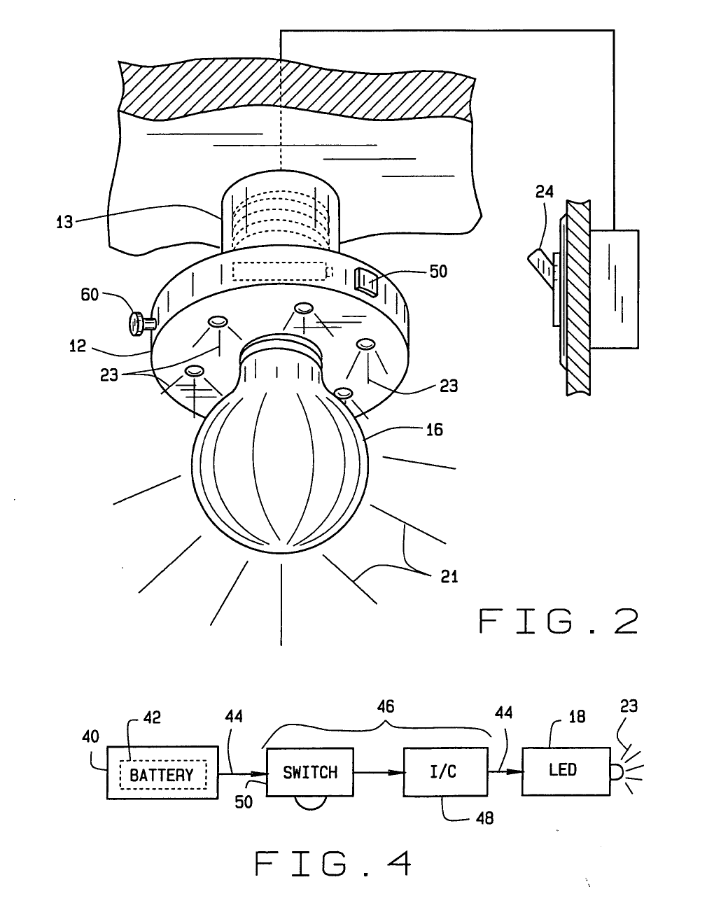

FIG. 2 shows the lighting device 10 installed into a ceiling-supported light socket 13 with the light bulb 16 emitting light 21 and the light sources 18 emitting light 23. As shown, the electrical power to the light socket 13 is controlled with the wall-mounted light switch 24 connected to the light socket 13. It should be noted, however, that the lighting device 10 can also be installed in the light socket of a wide range of lighting fixtures, such as floor lamps and desktop lamps.

A wide range of materials can be used for the base portion 12. Preferably, the base portion 12 is formed from a sufficiently lightweight material, such as plastic, that would allow the device 10 to be retrofit to an existing ceiling-supported light socket without the need for additional ceiling structural reinforcement to support the device 10 and without exceeding the limits of the ceiling socket.

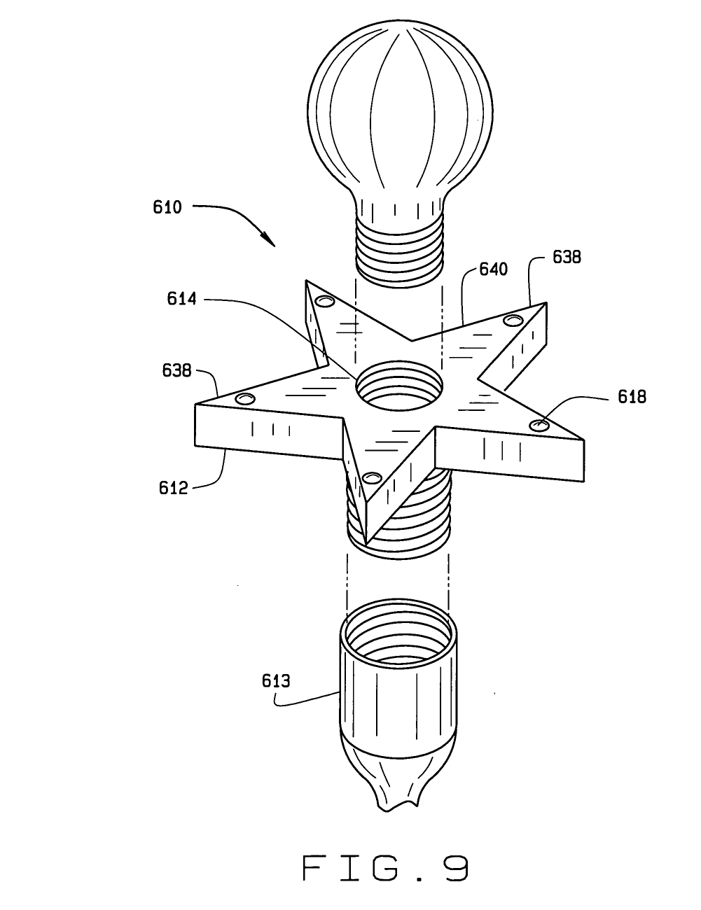

In addition, the base portion can also be provided in a wide range of shapes (circular, rectangular, star-shaped, triangular, etc.). For example, the base portion 12 in FIG. 1 is cylindrical, the base portion 112 in FIG. 3 is triangularly shaped, and the base portion 612 in FIG. 9 is star-shaped.

FIG. 4 illustrates a power source compartment 40 (FIG. 4) of the lighting device 10. The power source compartment 40 is adapted to receive therein a power source 42 (also shown in phantom in FIG. 1), which may be used as either a back-up power source or as the sole source of electrical power for operating the light sources 18. Conductive leads or wiring 44 electrically connect the light sources 18 to the power source 42 and a control circuit 46.

In at least some embodiments, the power source 42 provides a back-up or secondary source of power for operating the light sources 18. During normal operation, the base portion 12 supplies electrical power from the light socket 13 to the light sources 18 for operation thereof. However, when the light socket 13 is unable to apply electrical power to base portion 12, the power source 42 can supply back-up or auxiliary power to the light sources 18.

By way of example, one or more of the light sources 18 can receive electrical power from the power source 42 and automatically activate to emit emergency lighting during a power outage. The lighting device 10 can be adapted so that the emergency light emitted by the light sources 18 during the power outage is relatively dim. The dim light may be the result of the light sources 18 being set on a relatively low power level or result from less than all of the light sources 18 being turned on. In either case, the dim light should provide sufficient but not overwhelming illumination to allow a user to readily locate the device 10 and increase the intensity of the light 23, for example, by increasing the power level of the light sources 18 or by turning on all of light sources 18. Moreover, the device 10 can also be removed from the socket 13 to provide a portable light source (e.g., flashlight) for use during the power outage or other suitable times.

In the illustrated embodiment of FIGS. 1 through 4, the power source includes at least one AA-sized battery. However, it should be noted that the power source may be any suitable means of providing energy to the light sources including renewable batteries, rechargeable batteries, disposable batteries, solar cells positioned on an external surface of the base portion, and other suitable power sources.

To allow a user internal access to the power source compartment 40, for example, to install, replace, or remove batteries, the base portion 12 also includes a removable portion. The removable portion may be engaged with the base portion 12 using a suitable fastening system or method (e.g., a threaded connection, an interference fit, resilient ribs, among others).

In the embodiments in which the power source 42 is rechargeable, the base portion 12 is preferably electrically connected to the power source 42. This allow the base portion 12 to apply electrical power from the light socket 13 to the power source 42 for recharging the power source 42. Thus, the power source 42 should remain fully charged in the event of a power outage.

The light sources 18 will now be described in more detail. In the illustrated embodiment of FIG. 1, the light sources 18 include six (6) LEDs. However, other quantities of LEDs may also be employed. For example, FIG. 3 shows a lighting device 110 within only a single LED 118, whereas FIG. 9 shows a lighting device 610 with five LEDs 618. Alteratively, other types of light sources are also possible such as neon and electroluminescent light sources.

In the various embodiments 10, 110, 210, 310, 410, 510, 610, one or more of the various LEDs may produce light that has at least one attribute (e.g., color, intensity, blink speed, hue, saturation, brightness, etc.) different than the light produced by the other LEDs and/or the light bulb. By way of example, the LEDs 18 of lighting device 10 (FIG. 1) may produce white-colored light, whereas the other LEDs 18 may produce red-colored light. Rather than producing colored light, one or more of the LEDs 18 could produce broadband light that travels through a colored filter.

Indeed, the various lighting devices (e.g., 10, 110, 210, 310, 410, 510, 610) of the present invention can be configured to produce any of a wide range of colored light depending at least in part on user preference. User preference may, in turn, be based on any number of factors including the room in which the lighting device will be used and the user's interests.

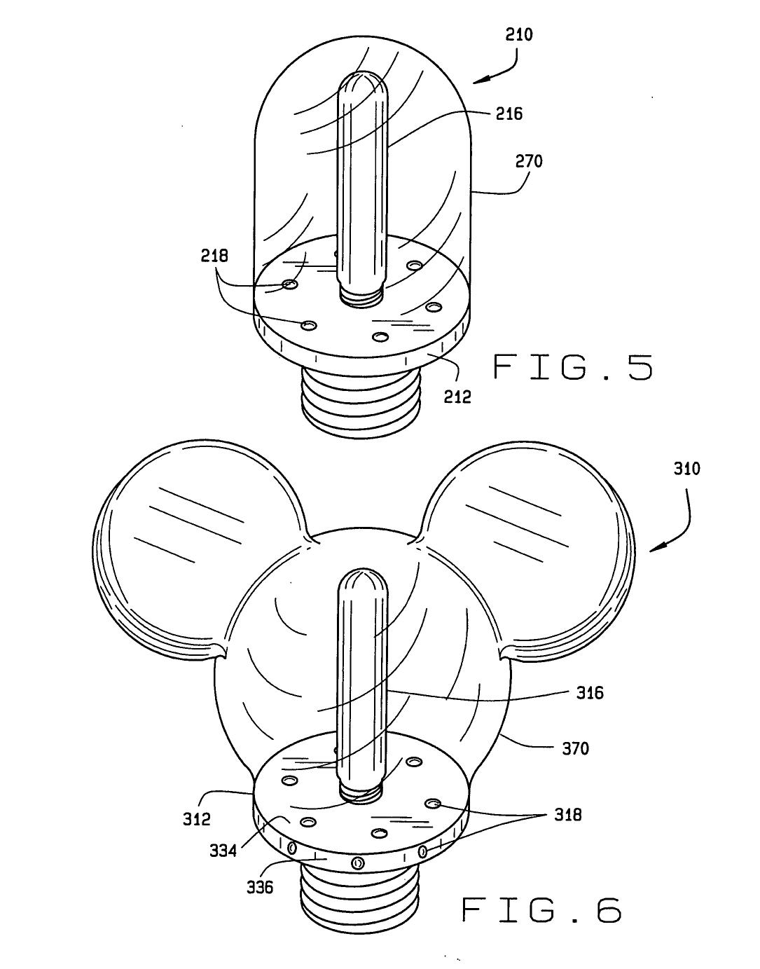

In the embodiment of FIG. 1, the LEDs 18 are circumferentially spaced along the surface 34 of the base portion 12 and around the device's socket 14. Alternatively, the LEDs 18 can be positioned at other portions of the base portion 12 and/or in other arrangements depending on the particular application in which the device 10 will be used. For example, FIG. 6 illustrates a lighting device 310 having LEDs 318 positioned along the surface 334 and side surfaces 336 of the base portion 312.

The LEDs 18 in FIG. 1 are positioned to direct light away from the base portion 12 at an angle substantially perpendicular to the surface 34 of the base portion 12. Alternatively, one or more of LEDs 18 can be positioned to direct light at an acute angle relative to the base portion 12.

Referring to FIGS. 1 and 4, the operation of the various LEDs 18 may be controlled by the control circuit 46 in accordance with user input to provide such features as blinking, strobing, color changes, and/or color phasing. As shown in FIG. 4, the control circuit 46 includes an integrated circuit/printed circuit assembly 48 (i.e., integrated circuits in a printed circuit assembly) positioned within the base portion 12. The control circuit 46 also includes at least one switch 50 for allowing a user to activate and deactivate the LEDs 18. The switch 50 may also allow the user to select from among various operating modes for the LEDs 18. Such modes may include an off-light mode, an on-light mode, a mode in which each of the LEDs 18 simultaneously emit steady or non-flashing light, a mode in which the LEDs 18 emit light intermittently, a mode in which the various LEDs 18 illuminate or blink at different times in accordance with a predetermined sequence or order, a mode in which the various LEDs 18 emit light that phases between or blends colors, a mode in which the LEDs 18 emit light randomly, and/or a mode in which the LEDs 18 pulsate to sounds. The sounds may be produced by the lighting device 10 itself (e.g., via a speaker built-in to the device 10) or a source external to the lighting device 10 (e.g., ambient sounds).

The controller 46 can also include a plurality of switches each of which is used to control the operation of an individual or group of LEDs 18. For example, the controller 46 may include a first switch for activating and deactivating the LEDs that emit white-colored light, and a second switch for activating and deactivating the LEDs that emit blue-colored light.

In the illustrated embodiment, the control circuit 46 includes a push-button switch 50 for switchably connecting the light sources 18 to the light socket 13 via the base portion 12 and/or to the power source 42. The switch 50 may also allow the user to cycle through various display modes or select a particular color for the LEDs 18 by successively pressing the switch 50. Additionally, the switch 50 may also allow the user to change the power level to the LEDs 18 and thus dim or brighten the intensity of the light by holding down the switch 50. For example, the user may dim the light emitted by the LEDs 18 to use the device 10 as a night light.

Alternatively, the switch 50 may include one or more other suitable switch means including motion-responsive switches, light-sensitive switches, compression switches, toggle switches, rotary switches, pull-chain switches, voice-activated switches, touch-sensitive switches, among others. In another embodiment, the switch 50 is a light-sensitive switch that causes the activation of the LEDs 18 when the ambient light level falls below a predetermined threshold.

In addition, the device 10 further includes another or second switch 60 that allows a user to activate and deactivate the light bulb 16. Although a wide range of switches can be used in the device 10, the illustrated embodiment includes a rotary switch 60. In other embodiments, a single switch can be used for selecting from amongst the various operating modes of the light bulb 16 and the LEDs 18.

The switches 50 and 60 allow a user to select from various operational modes for the device, including a mode in which only the LEDs 18 emit light, and an off mode in which neither the light bulb 16 nor the LEDs 18 emit light. The device 10 may also include a third mode in which the both the light bulb 16 and the LEDs 18 emit light.

FIG. 5 illustrates another exemplary embodiment of a lighting 210 that includes a removable cover 270. As shown, the cover 270 is engaged with the base portion 212 while being positioned over the light bulb 216 and LEDs 218.

To allow a user to install, replace, or remove the bulb 216, the cover 270 is removably engaged with the base portion 212. A wide range of suitable fastening systems or methods can be used to removably engage the cover 270 with the base portion 212 including a threaded connection, an interference fit, resilient ribs, among others.

The cover 270 can be either substantially entirely light-transmissive or include at least a portion which is light-transmissive to allow light from the LEDs 218 and the light bulb 216 to become externally visible. In one embodiment, the cover 270 is translucent and softens the light passing therethrough. In other embodiments, the cover is transparent.

The cover 270 can be provided in a wide range of colors and shapes such as dinosaurs, cartoon characters, fish, etc. For example, FIG. 6 illustrates a lighting device 310 having a cover 370 resembling a mouse's head. The particular shape of the cover can be determined at least in part by user preference. User preference can, in turn, be based on any number of factors including the particular room in which the lighting device will be used, the user's interests and the age of the user. For example, the cover can resemble a fish when the room in which the lighting device will be used is decorated with an under-the-sea motif (e.g., with wallpaper, curtains and/or beddings containing underwater images).

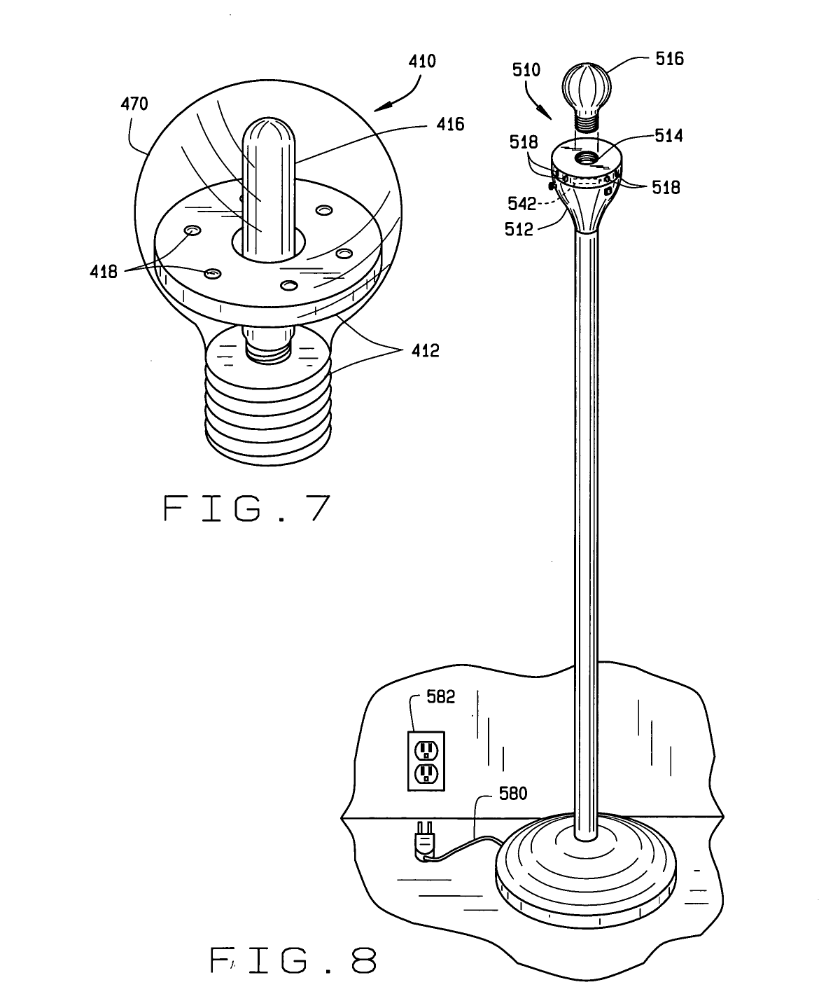

FIG. 7 illustrates another embodiment of the invention in which the device 410 includes a cover 470 integral with or fixedly attached to the base portion 412.

The various covers 270, 370, 470 can be formed from a wide range of materials. Preferably, the covers 270, 370, 470 are formed from a lightweight material, such as plastic. This, in turn, would allow the devices 210, 310, 410 to be retrofit to an existing ceiling-supported light socket without the need for additional ceiling structural reinforcement to support.

In addition, any one of the covers 270, 370, 470 may be formed of a material that is reactive or responsive to black light, which may be produced by the LEDs 218, 318, 418 and/or the light bulb 216, 316, 416. Exemplary materials that are responsive to black light include plastic materials containing phosphor (e.g., Zinc Sulfide, Strontium Aluminate) and fluorescent materials.

Another embodiment of the invention provides a lighting device that includes electrical terminals (e.g., wires, screws, pig-tails, etc.) for electrical connection to an external power supply. The lighting device further includes at least one LED and a socket for receiving a light bulb. The electrical terminals are electrically connected to the socket to apply electrical power from the external power supply to the light bulb. The electrical terminals can also be electrically connected to the LED to apply electrical power from the external power supply to the LED.

FIG. 8 illustrates an exemplary embodiment of a lighting device 510 that receives electrical power through an electrical cord 580. The electrical cord 580 is sized for connecting with a standard wall outlet 582. Additionally, or alternatively, the lighting device 510 may include an AC adapter port.

The base portion 512 of device 510 is electrically connected to the device's socket 514 such that the base portion 512 receives electrical power through the cord 580 which is then applied for operation of the light bulb 516. The base portion 512 can also be electrically connected to the LEDs 518 and the power source 542 to apply power received through the cord 580 for operation of the LEDs 518 and/or for recharging the power source 542 within the base portion 512.

In the illustrated embodiment, the base portion 512 is configured for placement upon a horizontal support surface, such as a floor or desktop. Accordingly, the device 510 can be used as a floor lamp or desktop lamp. Alternatively, the lighting device can be configured to be mounted on a wall or retrofitted to an existing ceiling junction box.

FIG. 9 illustrates another embodiment of a lighting device 610 that includes a star-shaped base portion 612 having five legs or points 640. The lighting device 610 also includes a plurality of light sources 618 each of which is positioned adjacent a tip or end portion 638 of a corresponding star leg 640. In addition, the base portion 612 is electrically connected to the device's socket 614 to apply electrical power from the light socket 613 to the light bulb 616 received within the device's socket 614. The base portion 612 is also electrically connected to each of the light sources 618 to apply electrical power from the light socket 613 to the light source 618. Although not shown in FIG. 9, the base portion 612 can be adapted to receive therein a power source for applying electrical power to the light source 618. In which case, the power source can provide the sole source of electrical power or back-up electrical power to the light sources 618.

In another form, the present invention provides a method that in one embodiment generally comprises engaging a light socket with a base portion of a device having at least one light source and a socket for receiving a light bulb. The method may further include applying electrical power to the light source and/or to the light bulb, with the electrical power being provided from a light socket and/or a power source positioned within the base portion. Additionally, the method may also include engaging a light bulb with the device's socket; positioning a cover over the light bulb engaged with the device's socket; removing a cover from the device prior to engaging the light bulb with the device's socket; and/or removing a light bulb from the light socket prior to engaging the light socket with the base portion.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

1. A lighting device comprising:
a base portion for engaging a light socket;
a socket for receiving a light bulb; and
at least one light source coupled to the base portion;
the base portion being electrically connected to the device's socket and the light source for applying electrical power from the light socket to the light source and to the light bulb.

2. The lighting device of claim 1, wherein:
the device's socket is a medium base socket; and
the base portion is engageable with a medium base socket.

3. The lighting device of claim 1, wherein the light source includes at least one LED.

4. The lighting device of claim 1, wherein the light source includes at least one LED, and wherein the light bulb is a light source other than an LED.

5. The lighting device of claim 1, wherein the base portion is adapted to receive therein a power source for supplying back-up power to the light source.

6. The lighting device of claim 5, wherein the base portion is electrically connected to the power source for applying electrical power from the light socket to the power source for recharging the power source.

7. The lighting device of claim 1, wherein:
the device's socket includes a threaded portion adapted to threadedly receive a threaded portion of the light bulb; and
the base portion includes a threaded portion adapted to be threadedly received within a threaded portion of the light socket.

8. The lighting device of claim 7, wherein the base portion is removably engaged with the threaded portion.

9. The lighting device of claim 1, wherein the light bulb includes at least one of:
an incandescent light bulb;
a halogen light bulb;
a fluorescent light bulb; and
a black light bulb.

10. The lighting device of claim 1, further comprising a control circuit for controlling the operation of the light source.

11. The lighting device of claim 10, wherein the control circuit includes:
at least one integrated circuit coupled to the base portion and the light source; and
at least one switching device coupled to the integrated circuit.

12. The lighting device of claim 1, further comprising a cover sized to be received over the light bulb, at least a portion of the cover being light-transmissive.

13. The lighting device of claim 12, wherein the cover is removably engaged with the base portion.

14. The lighting device of claim 12, wherein:
the cover includes a portion responsive to black light; and
at least one of the light source and the light bulb is oriented to direct black light at the black light-responsive portion of the cover.

15-32. (canceled)

33. A lighting device comprising:
electrical terminals for electrical connection to an external power supply;
a socket for receiving a light bulb; and
at least one LED;
the electrical terminals being electrically connected to the socket and the LED for applying electrical power from the external power supply to the light bulb and to the LED.

34. The lighting device of claim 33, further comprising a base portion configured to allow the lighting device to be supported upon a horizontal support surface.

35. The lighting device of claim 33, further comprising an electrical cord for electrically connecting the electrical terminals to a wall outlet.

36. The lighting device of claim 33, wherein the socket is a medium base socket.

37. The lighting device of claim 33, further including a power source container for receiving therein a power source for supplying back-up power to the LED.

38. The lighting device of claim 37, wherein the electrical terminals are electrically connected to the power source for applying electrical power from the external power supply to the power source for recharging the power source.

39. The lighting device of claim 33, wherein the light bulb includes at least one of:
an incandescent light bulb;
a halogen light bulb; and
a black light bulb.

40. The lighting device of claim 33, further comprising a control circuit for controlling the operation of the LED.

41. The lighting device of claim 33, further comprising a cover sized to be received over the light bulb, at least a portion of the cover being light-transmissive.

42. The lighting device of claim 33, wherein the cover is removably engaged with the base portion.

43. The lighting device of claim 33, wherein:
the cover includes a portion responsive to black light; and
at least one of the LED and the light bulb is oriented to direct black light at the black light-responsive portion of the cover.

44. A lighting device comprising:
a base portion for engaging a light socket;
a socket for receiving a light bulb; and
at least one light source;
the base portion being electrically connected to the device's socket for applying electrical power from the light socket to the light bulb;
the base portion being adapted to receive therein a power source for applying electrical power to the light source.

45. The lighting device of claim 44, wherein:
the base portion is electrically connected to the light source for applying electrical power from the light socket to the light source; and
the power source is configured to supply back-up power to the light source when the base portion is unable to receive electrical power from the light socket.

46. The lighting device of claim 44, wherein the base portion is electrically connected to the power source for applying electrical power from the light socket to the power source for recharging the power source.

47. A lighting device comprising:
electrical terminals for electrical connection to an external power supply;
a socket for receiving a light bulb;
at least one LED; and
at least one power source compartment for receiving a power source therein for applying electrical power to the LED;
the electrical terminals being electrically connected to the socket and the LED for applying electrical power from the external power supply to the light bulb and to the LED.

48. The lighting device of claim 47, wherein:
the electrical terminals are electrically connected to the LED for applying electrical power from the external power supply to the LED; and
the power source is configured to supply back-up power to the LED when the electrical terminals are unable to receive electrical power from the external power supply.

49. The lighting device of claim 47, wherein the electrical terminals are electrically connected to the power source for applying electrical power from the external power supply to the power source for recharging the power source.

50. A lighting device comprising
a threaded socket for threadedly engaging a threaded portion of a light bulb;
a base portion including a threaded portion for threadedly engaging a threaded portion of an existing light socket, the base portion being electrically connected to the device's socket for applying electrical power from the existing light socket to the light bulb; and
a member having at least one LED, the member configured in a generally annular shape having a central opening, the member being disposed generally around at least a portion of the light bulb received within the central opening when the light bulb is engaged with the device's socket.

51. The lighting device of claim 50, wherein the member includes at least one power source compartment for receiving a power source therein for applying electrical power to the LED.

52. The lighting device of claim 50, wherein the base portion is electrically connected to the LED for applying electrical power from the existing light socket to the LED.

53. The lighting device of claim 50, wherein an outer perimeter of the member is generally circular, and wherein a periphery of the opening is generally circular.

54. The lighting device of claim 50, wherein the base portion is engageable with a medium base socket.

55. The lighting device of claim 50, further comprising a cover sized to be received over the light bulb and the member having the at least one LED.

56. The lighting device of claim 55, wherein the cover is removably engaged with the base portion.

57. The lighting device of claim 55, wherein the outer features of the lighting device with the cover simulate the outer features of an incandescent light bulb.
